(19) United States
(12) Patent Application Publication
(10) Pub. No.: US 2006/0226576 A1
(43) Pub. Date: Oct. 12, 2006

(54) Microstructure devices and their production

(76) Inventors: Peter O'Brien, County Cork (IE); Jan Kruger, County Cork (IE); Gareth Redmond, Cork (IE)

Correspondence Address: JACOBSON HOLMAN PLLC, 400 SEVENTH STREET N.W., SUITE 600, WASHINGTON, DC, 20004, US

(21) Appl. No.: 11/376,561

(22) Filed: Mar. 16, 2006

Related U.S. Application Data
(63) Continuation of application No. PCT/IE04/00126, filed on Sep. 17, 2004.

(30) Foreign Application Priority Data
Sep. 17, 2003 (IE) 2003/0683
Dec. 11, 2003 (IE) 2003/0925
Mar. 22, 2004 (IE) 2004/0176
Mar. 22, 2004 (IE) 2004/0177
Mar. 26, 2004 (IE) 2004/0190

(51) Int. Cl. B29C 59/00

(52) U.S. Cl. 264/293; 264/299; 204/600

(57) ABSTRACT

An embossing master (20) is produced by successively applying epoxy layers (2, 10) over a silicon substrate (1) and selectively exposing them to UV to cross-link according to a pattern. Non-exposed epoxy is developed away to leave a pattern of cured epoxy at each level. This provides a multi-level master, with a desired 3D configuration. The master (20) is then used to emboss a polymer blank to provide a substrate (80) and a different master is used to emboss a blank to provide a superstrate (90). The substrate (80) has aligned socket and channel grooves (80, 81) and the superstrate (90) has a socket groove (91). When the superstrate is mated with the substrate, there is a socket for receiving a fluidic capillary or a detection waveguide. The capillary or waveguide is aligned with the channel for optimum fluidic flow or optical detection.

This is a CONTINUATION of PCT/IE2004/000126 filed 17 Sep. 2004 and published in English.

### INTRODUCTION

1. Field of the Invention

The invention relates to devices having features in the size range of up to millimetres, referred to as “microstructure devices”. Such features may be for waveguiding in an optical device or for channelling fluid in a microfluidic device, for example.

2. Prior Art Discussion

Optical fibres and fluidic capillaries have similar physical and dimensional features. Both are cylindrical in cross-section with typical diameters of the same order. Both may have an outer cladding and inner core regions. The core is filled to enable waveguiding within the optical fibre, while it remains unfilled to enable fluid flow in the capillary.

Precise alignment and connection of optical fibres and capillaries to planar waveguides and planar fluidic chips respectively is technically challenging. For example, many techniques exist to achieve fibre alignment with the planar structure such as butt-coupling and fixing the fibre to the planar waveguide using laser welding or UV-cured epoxies. Passive alignment using grooves is attractive as it can eliminate time-consuming work involved in matching the optical fibre core to the planar waveguide core area. The most common approach to achieve fibre alignment grooves has been to etch V-grooves in Silicon.

Silicon, due to its crystallographic nature can be chemically etched to form well defined deep grooves having a V-shape. Subsequently, active and passive waveguide devices such as diode lasers and waveguide couplers can be integrated on to the Silicon platform and this enables optical fibres to be brought in close and precise contact with the planar waveguides. A similar approach can be used to etch V grooves in Silicon and insert the capillaries in the planar fluidic chip.

However, a problem with these interconnection techniques is the difficultly in achieving planarity between the level of the fibre or capillary core region and the on chip optical or fluidic components. For example, it is difficult to define an alignment V-groove and subsequently define an optical waveguide, with both components aligned in the same plane.

The invention is therefore directed towards providing improved microstructure device manufacture, and microstructure devices.

### SUMMARY OF THE INVENTION

According to the invention, there is provided a method of manufacturing a microstructure device comprising the steps of:
producing an embossing master with multi-level microstructure features, and
embossing a polymer blank with the master to provide corresponding microstructures in the blank.

In one embodiment, the embossing master is produced by (a) depositing a film of curable material on a base, (b) selectively exposing the material to cure it to the shape of the master and (c) developing away non-exposed material.

In another embodiment, the steps (a), (b) and (c) are repeated for each of one or more subsequent layers.

In one embodiment, there is a different exposure pattern for at least two layers.

In one embodiment, the master has features for embossing both socket and channel grooves in the blank.

In one embodiment, a film of material is common to features for both socket and channel grooves, and at least one subsequent film is only for the socket groove feature.

In one embodiment, the material is a cross-linkable photoresist, preferably SU8.

In one embodiment, the material is cured by exposure to UV radiation.

In one embodiment, the method comprises the further step of applying a top blanket of material and developing away all of the blanket so that master features have rounded corners.

In one embodiment, the polymer blank is embossed to provide a microfluidic device.

In one embodiment, both a substrate and a superstrate are embossed to form grooves and mating of the superstrate to the substrate forms a microfluidic channel.

In one embodiment, a radiation waveguide socket and a capillary socket are formed by embossing corresponding socket grooves in polymer blanks to provide a substrate and a superstrate, and joining the superstrate to the substrate.

In one embodiment, the socket comprises a groove for receiving a radiation waveguide.

In one embodiment, the microfluidic device is a separation and analysis device.

In one embodiment, the blank is embossed to form recesses of different configurations to receive and support optical components, to provide an optical submount.

In one embodiment, the recesses include V-shaped grooves in cross-section for supporting waveguides, and a recess which is symmetrical about a normal axis for supporting a ball lens.

In one embodiment, the blank is embossed to include a waveguide groove structure, and a cover is placed over the structure to complete a hollow waveguide.

In one embodiment, the cover is also of embossed polymer material with a waveguide groove structure corresponding to that of the substrate so that together they complete a hollow waveguide.

In one embodiment, the waveguide structure is coated with a metal layer.

In another embodiment, the waveguide structure is evaporated with metal, such as gold.

In one embodiment, the evaporation method is electron-beam or thermal evaporation.

In one embodiment, the metal thickness range is 0.1 microns to 50 microns.

In one embodiment, the waveguide is configured for millimetre-range operation.

In one embodiment, the microstructure features have a sub-micron accuracy.

In one embodiment, the polymer blank is of thermoplastic material.

In one embodiment, the polymer blank is heated above its glass transition temperature for embossing.

The invention also provides a microfluidic device comprising a substrate and a superstrate sealed together, the substrate and the superstrate being of polymer material and having grooves which are in registry to together form at least one socket to receive a fluidic capillary or optical waveguide, and a fluidic channel.

In one embodiment, the channel terminates at the socket.

In one embodiment, the dimensions of the socket are such that a core of the capillary or the waveguide is aligned with the channel.

In one embodiment, the device comprises both fluidic capillary sockets and waveguide sockets

In one embodiment, the capillary or waveguide is bonded into the socket.

The invention also provides an optical submount comprising a polymer base with embossed recesses for receiving and supporting optical components.

### DETAILED DESCRIPTION OF THE INVENTION

### Brief Description of the Drawings

The invention will be more clearly understood from the following description of some embodiments thereof, given by way of example only with reference to the accompanying drawings in which:—

FIG. 1 is a flow diagram illustrating production of an embossing master for production of a microstructure device;

FIG. 2 is a perspective view of an embossing master;

FIG. 3 is a perspective view of embossed socket and channel grooves;

FIG. 4 is a photograph of a number of masters before dicing and

FIGS. 5 and 6 are perspective and end views of an embossed microstructure;

FIGS. 7 and 8 are photographs of alternative microstructures;

FIGS. 9 and 10 are photographs showing a capillary and a fibre, respectively, inserted in microstructure socket grooves;

FIG. 11 is a plan view of an integrated microfluidic HPLC device of the invention;

FIG. 12(a) is a perspective view of a sample inlet socket groove, and FIG. 12(b) is a cross-sectional view of a fluidic capillary with corresponding dimensions illustrated;

FIG. 13 is a diagrammatic end view of bonding of a superstrate to the substrate of FIG. 12(a); and

FIG. 14 is a diagrammatic axial cross-sectional view of the bonded parts with a capillary shown diagrammatically by interrupted lines;

FIG. 15 is a perspective view showing connection of an optical fibre to a socket groove of an alternative substrate;

FIG. 16 is a diagrammatic side view showing embossing of a polymer blank to provide an optical device submount;

FIGS. 17(a) and 17(b) are diagrammatic cross-sectional views showing placement of optical components on the submount;

FIG. 18 is a plan view of the submount, and

FIG. 19 is a plan view after placement of the components;

FIG. 20 is a photograph of an optical submount;

FIG. 21 is a perspective view of an embossing master for a waveguide device,

FIG. 22 shows embossed polymer parts, and

FIG. 23 shows a waveguide comprising the two polymer parts mated together; and

FIG. 24 is a photograph of a device with a bonded substrate and superstrate.

### DESCRIPTION OF THE EMBODIMENTS

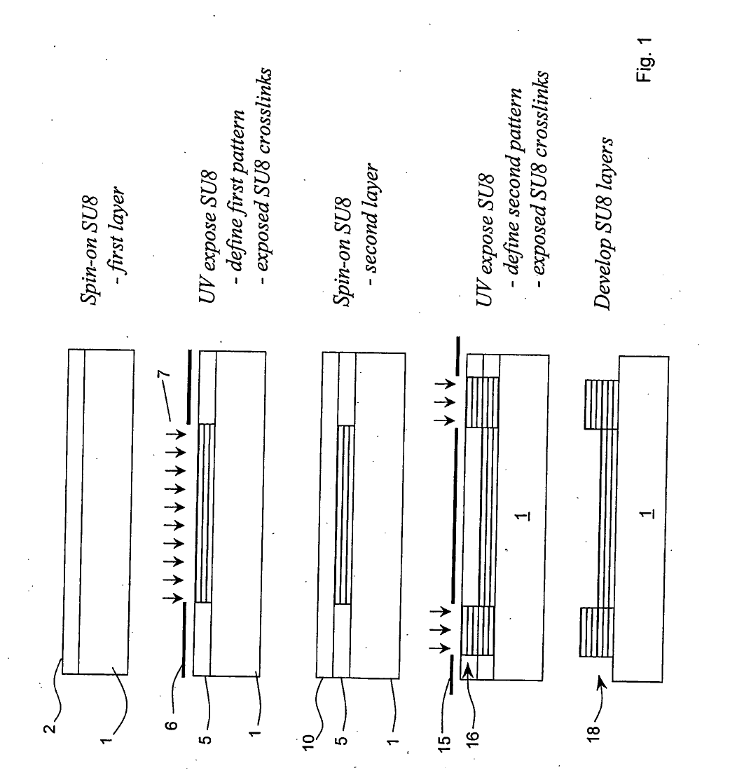

Referring to FIG. 1 production of a master for embossing microstructures in a polymer blank is shown. A silicon substrate 1 is provided, and SU8 2 is spun on. The depth is preferably kept small to optimise adhesion.

The initial blanket 2 of SU8 is patterned to provide a layer 5 by exposure of a central area to UV 7 through a mask 6. A second blanket 10 of SU8 is spun onto the layer 5. This is then formed into a patterned layer 16 by selectively exposing it to UV through a mask 15.

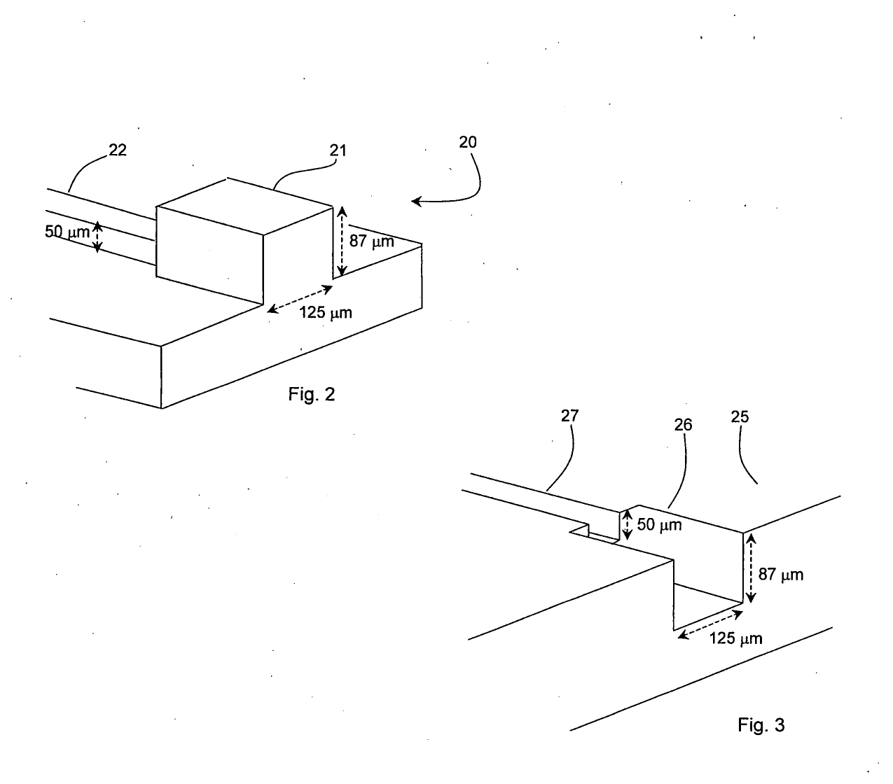

The non-exposed SU8 is then developed away to reveal a three-dimensional master structure. One end of the structure 18 is shown in FIG. 2. The dimensional cross-sections depend on the application. The ends are for embossing sockets in polymer blanks, and the central part for embossing channels. The dimensions are approximately 6 μm×6 μm for single mode waveguides and 50 μm×50 μm for multimode waveguides, and the socket has a width of approximately 125 μm and a total height of 87 μm. They will vary for microfluidic applications, the key parameters being the capillary inner and outer diameters.

In an alternative embodiment a final blanket of SU8 is applied and completely developed away. This helps to define sloped sidewalls in the microstructures, thus enabling better de-moulding or separation of the master from the embossed polymer blank during production of microstructure devices.

Also, instead of the SU8 curing temperature of 90° C., it may instead be heated several degrees, above the recommended hard bake temperature of 90° C. This facilitates re-flow of the SU8, again giving rise to rounded corners/edges.

In this process, the UV wavelength is preferably 365/405 nm. The embossing can consist of up to 10 layers of various thickness. These include a first layer referred as support layer, consisting of SU8. This covers the surface of the substrate and has a thickness of typically 5 to 100 microns.

The subsequent layers may be referred to as structural layers. Individual structural layers can have a thickness of 1 to 200 microns (typically 50 and 37 microns). The sidewalls of individual layers have an angle of 45 to 90 degrees to the substrate as shown in the photographs of FIGS. 5 to 8.

All structural layers and support layers can be covered with a final layer, referred to as protection layer. The protection layer can consist of a metal with a thickness of 0.1 to S0 micron.

The following sets out a more detailed example process.

Example of Master Production

Fabrication of an embossing master consisted of a cleaning procedure, a series of photo-lithography cycles that involve the deposition, UV-exposure and cross-linking of one support and two structural layers of SU8. A combined development of these SU8 layers takes place when last photo-lithography cycle is completed and after the substrate has returned to room temperature.

The substrate was a 4″ silicon wafer. The substrate was pre-cleaned by means of standard Piranha/RCA cleaning methods before any coating begins.

The support layer was a blanket of SU8 with a thickness of 35 micrometer. This layer was deposited by spin coating, softbaked at 90° C. for 90 minutes (temperatures and duration for soft and post-exposure-bakes refer to the usage of hot-plates), exposed with UV light at 405 nm/365 nm and with a dose of 200 mJ/cm2 and post-exposure-baked at 95° C. for 25 minutes.

The structural layers were deposited in a similar fashion to the support layer, by spin coating SU8. The thickness of the first structural layer was 50 micrometer. The parameters for softbake and UV exposure are identical to the process parameters of the support layer.

The second structural layer had a thickness of 37 microns. It was deposited on top of the first structural layer. This layer was softbaked at 90° C. for 90 minutes, exposed with UV light at 405 nm/365 nm with dose of 200 mJ/cm2 and post-exposure-baked at 115° C. for 25 minutes.

The development was carried within 6 to 12 hours after the substrate had cooled down to room temperature. The development took 15 mins and was carried out in a bath of EC solvent.

The final fabrication steps involved ‘packaging’ of the Silicon wafer with the developed SU8 structures of the embossing master. The Silicon wafer was diced to the required shape of the embossing area, 60 mm×60 mm, and subsequently adhered to a supportive handling plate (i.e. glass 100 mm×100 mm×2 mm) using a high temperature glue (i.e. HTK Ultrabond series). The fabrication of the embossing master was completed when the glue was fully crosslinked.

In FIG. 2 the socket-forming part of the master is indicated by the numeral 21, and the channel-forming part by the numeral 22. The overall master, after singulation, being indicated by the numeral 20.

Referring to FIG. 3 a polymer blank 25 is embossed by the master 20 to form a socket groove 26 and a channel groove 27. Thus, microstructure features at different levels are formed in a single step arising from the multilevel construction of the master 20.

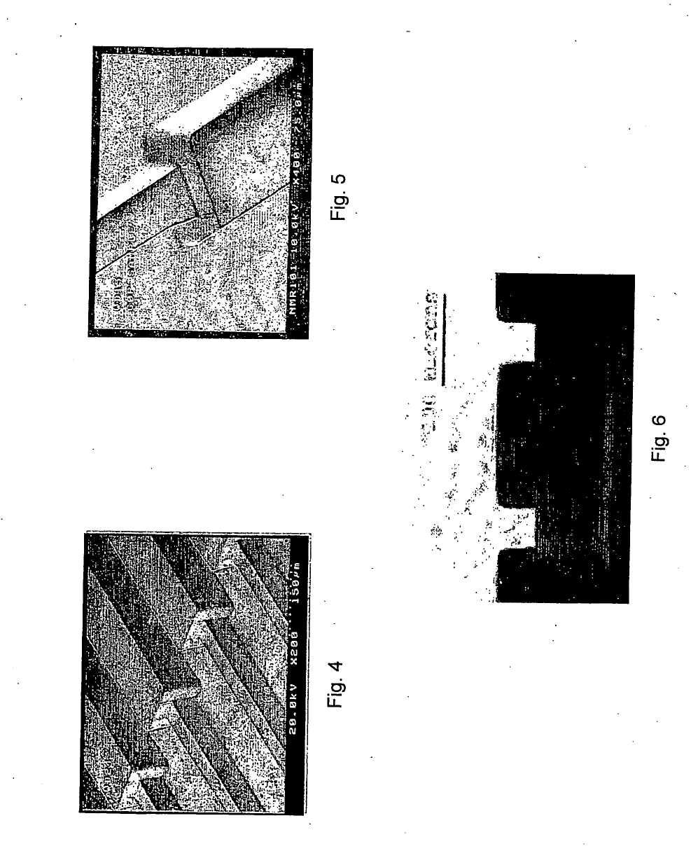

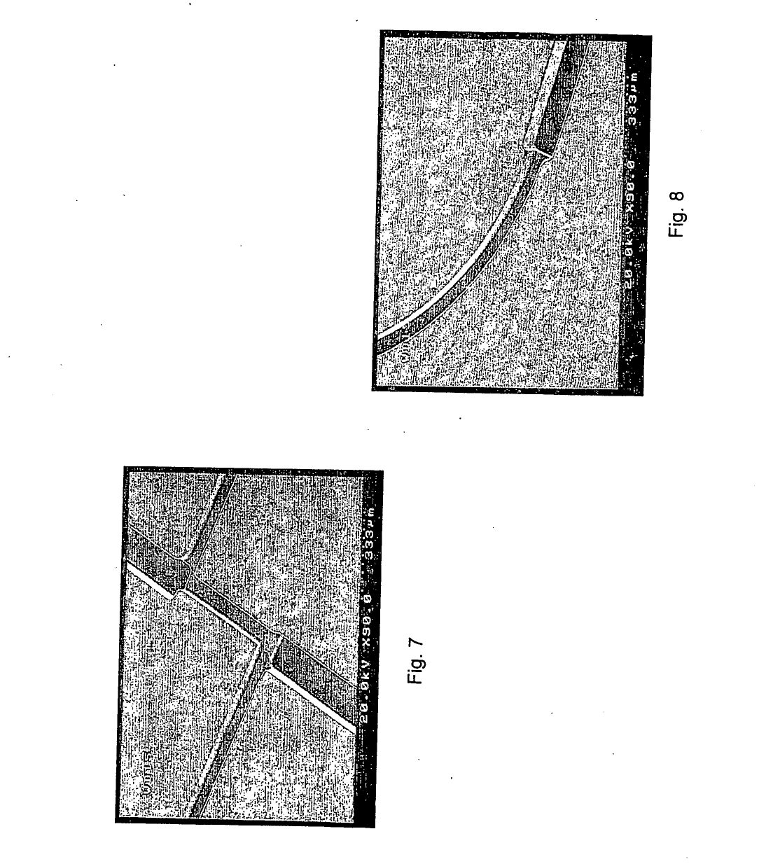

FIG. 4 is a photograph of a series of masters before singulation. FIGS. 5 to 8 inclusive are photographs of microstructures in polymer. It will be appreciated from these photographs that the accuracy is exceptionally good, and that a wide variety of different microstructure features can be embossed. FIG. 5 shows a socket and a channel groove, and FIG. 6 an end view of the grooves. FIG. 7 shows straight microfluidic device channel and socket grooves, and FIG. 8 shows curved grooves. This demonstrates versatility of the process. The photographs of FIGS. 3 and 5 to 8 are of one polymer part, say, a substrate. A superstrate is formed in a similar manner with a desired pattern to mate with that of the substrate. Corresponding grooves of the substrate and superstrate mate to form a microfluidic device channel, and corresponding socket grooves mate to form a socket to receive and retain a microfluidic capillary or an optical fibre aligned with the channel for delivery or outlet of fluid or for optical inspection.

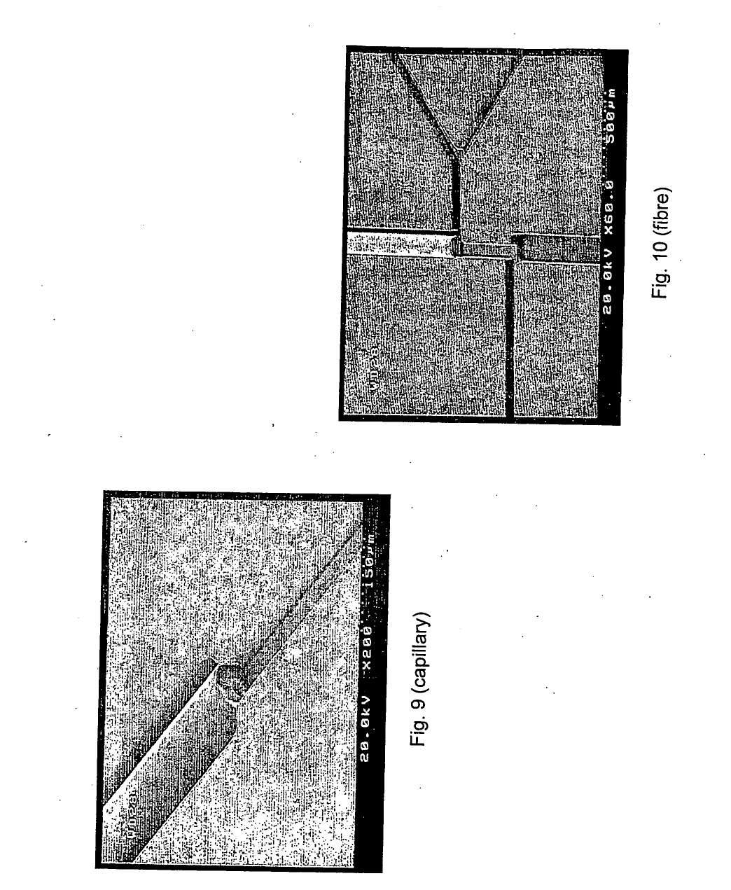

For example, FIG. 9 shows a capilliary inserted in a socket groove before addition of the superstrate. It will be noted that the capilliary core is at the level of the channel groove. In this case the superstrate lies flat over the channel groove, but it has a socket groove to add additional height to the socket groove of the substrate to form the socket. FIG. 10 shows an optical fibre in a socket groove of a substrate for inspection of a channel.

In the above processes, for embossing, the master is pressed into the polymer substrate under the influence of high temperature and pressure. The process temperature is sufficiently above the glass transition temperature of the polymer material to enable the polymer to flow and form a negative impression of the master structures. It is also desirable to use a polymer material with a relatively high glass transition temperature as this enables additional high temperature processes such as adhesive or epoxy curing to be performed on the surface of the polymer submount. Examples of preferred polymer materials are Poly Methyl MethAcrylate (PMMA), Cyclic Olefin Polymer (COP) and Polycarbonate (PC).

Example of Embossing Procedure

Fabrication and assembly of a microfluidic device (i.e. high pressure UV-flow cell) consists of 4 process stages, which involve i) the embossing of individual device components (i.e. substrate, superstrate); several device components (i.e. 2,9,16) can be joined together to an array of one embossed part. ii) cutting of the embossed part and separation into individual device components and the cutting and removal of excrescent embossed material. iii) the assembly and welding of the individual device components (i.e. substrate and superstrate) to one device and iiii) the interconnection with capillaries and/or optical fibres.

Device components referred to as substrates contain a network of microchannels, passive interconnection and alignment features for capillaries and optical fibres, and for a self-aligned assembly. Device components referred to as superstrate contain interconnection and alignment features for capillaries and optical fibres, and for a self-aligned assembly.

As an example, a high pressure UV-flow cell consists of 2 components, a substrate and superstrate, two capillaries and two fibres. As material for its substrate/superstrate serves COP 330 or COP 480.

i) Embossing

All materials and components are cleaned with Acetone and IPA before loaded into the hot embossing system. As coarse material serve COP plates with dimensions of 64×43×2 mm. Loading and unloading takes place at 110° C. After loading the coarse material into the embossing system the embossing chamber is evacuated. Embossing of individual device components takes place when the temperature inside the embossing chamber reaches 165° (COP330) or 175° C. (COP480). At that temperature a force of 6 k Newton is applied and held for the duration of 5 minutes. Demoulding of the embossed parts take place at a temperature of 110° C. The duration of an entire embossing cycle including loading/unloading, heating/cooling is approximately 25 minutes.

ii) cutting

Embossed parts are cut into individual device components using a dicing saw.

iii) assembly

Assembly and welding of substrate and superstrate takes place in the embossing system. The embossing chamber is loaded with a sandwich of 1 substrates and 1 superstrate, whereby the two embossed surfaces of substrate and superstrate must face one another. Loading and unloading takes place at 110° C. During the first welding stage the embossing chamber is evacuated and a force of 15 to 25 Newton is applied. The temperature inside the embossing chamber is then ramped up to 135° C. (COP330) or to 145° C. (COP480). The duration of an entire welding cycle including loading/unloading, heating/cooling is approximately 10 minutes.

iiii) Interconnection

In order to connect the device to i.e. external pumps, liquid delivery systems, light sources etc. fused silica capillaries and/or optical fibres are inter-connected with the device. Hereby, the capillaries/fibres are inserted into the appropriate interconnection ports of the device and sealed using a fast setting uv-curable glue (i.e. Norland Electronic Adhesive NEA121).

After embossing has been completed using both masters, the embossed polymer substrate and superstrate can be integrated using self-alignment features to snap-and-fit together. They are then firmly sealed using a thermal or epoxy adhesive process.

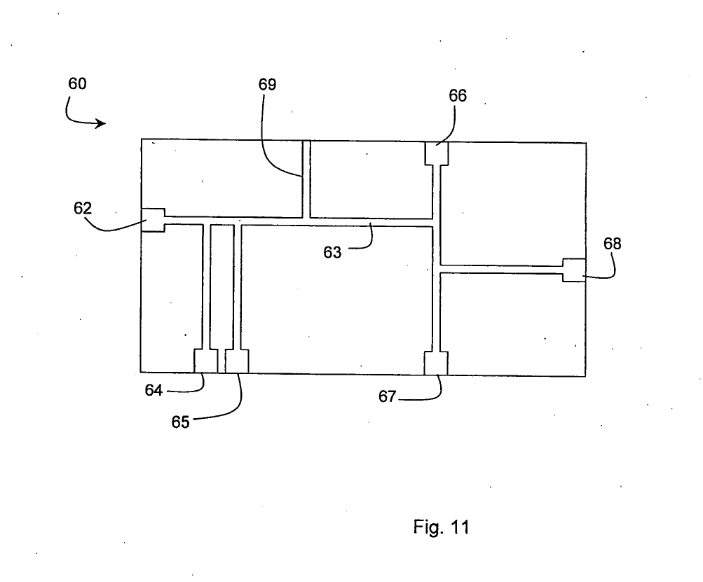

Referring to FIG. 11 an integrated microfluidic high pressure liquid chromatography (HPLC) device 60 comprises injection, separation, and detection features. The device 60 comprises a mobile phase inlet socket 62 at the start of a separation column 63 with integrated frits at both ends. Sample inlet 64 and outlet 65 ports are connected by microchannels to the separation column 63. The device 60 also comprises optical input and output ports 66 and 67 for radiation absorption and detection. A waste outlet port 68 is linked with the end of the separation column 63. An input port 69 is used for inlet of stationary phase microbeads, this port being sealed once the microbeads are in place.

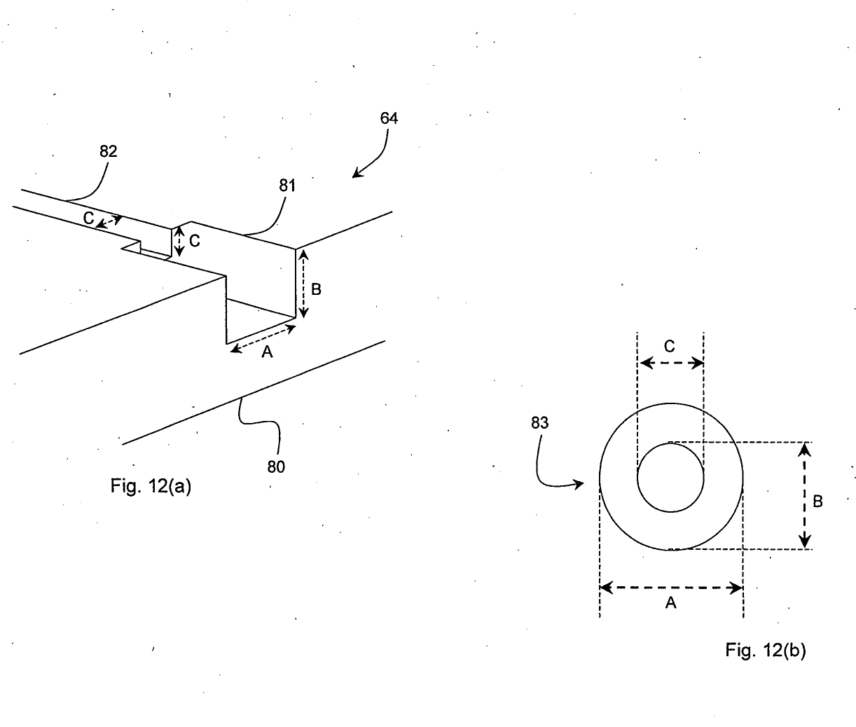

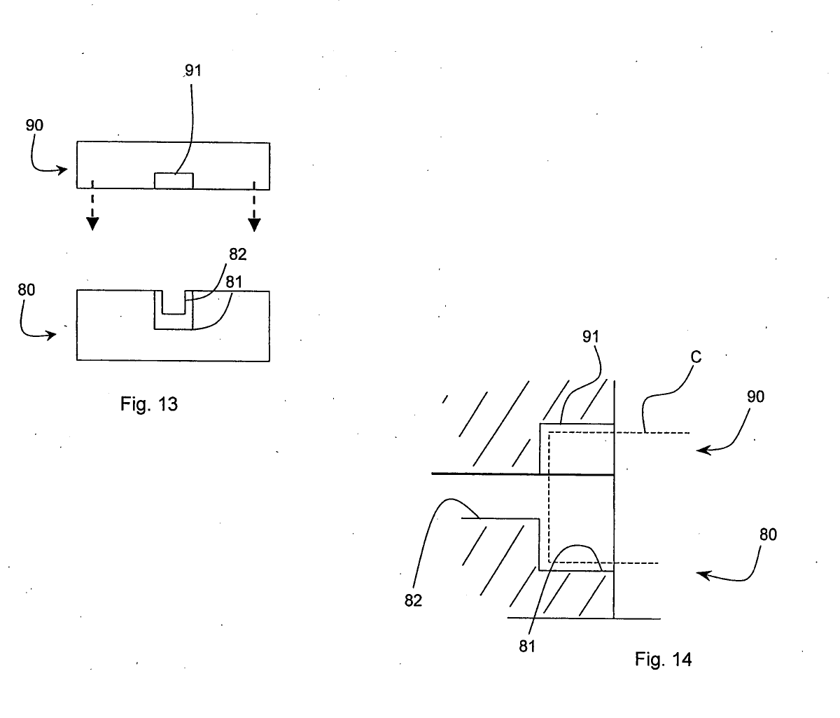

Referring to FIG. 12, the sample inlet port 64 is illustrated. However, this is similar to all of the fluidic inlet and outlet ports of the device 60. The port 64 comprises, machined in a polymer substrate 80, a capillary socket groove 81 and a channel groove 82. The channel groove 82 extends from an end face of the socket groove 81. A fluidic capillary 83 is inserted in the socket groove 81. It will be appreciated from FIG. 12 that the width of the socket groove 81 is exactly matched to the outside diameter of the capillary 83, and the width of the channel groove 82 is exactly matched to the inside diameter of the capillary 83. In this embodiment, the dimension values are as follows:—

A: 150 microns

B: 100 microns

C: 50 microns

However, these dimensions can vary in the range:—

A: 100-2000 microns

B: 100-2000 microns

C: 1-1000 microns

As shown in FIGS. 13 and 14, completion of the device is achieved by placing a polymer superstrate 90 on the substrate 80. The polymer superstrate 90 also contains a socket groove 91 to enable exact alignment of the fluidic capillary with the channel. The dimensions of the socket grooves in the polymer superstrate 90 are determined by the inner and outer fluidic capillary dimensions (A-B). The full height of the channel is provided by the substrate groove 81, and so the superstrate 90 lies flat over the groove 81. The capillaries and optical fibres are adhered in place in the sockets by adhesive.

A further feature of the device is use of stepped height structures in the substrate and superstrate to enable overlap between the fluidic microchannel, the inner dimensions of the fluidic capillary, and the light guiding core region of an optical fibre, terminating in a socket. This maximises the coupling of light into and out of the channel, thus maximising the absorption of light by the sample and the detection signal.

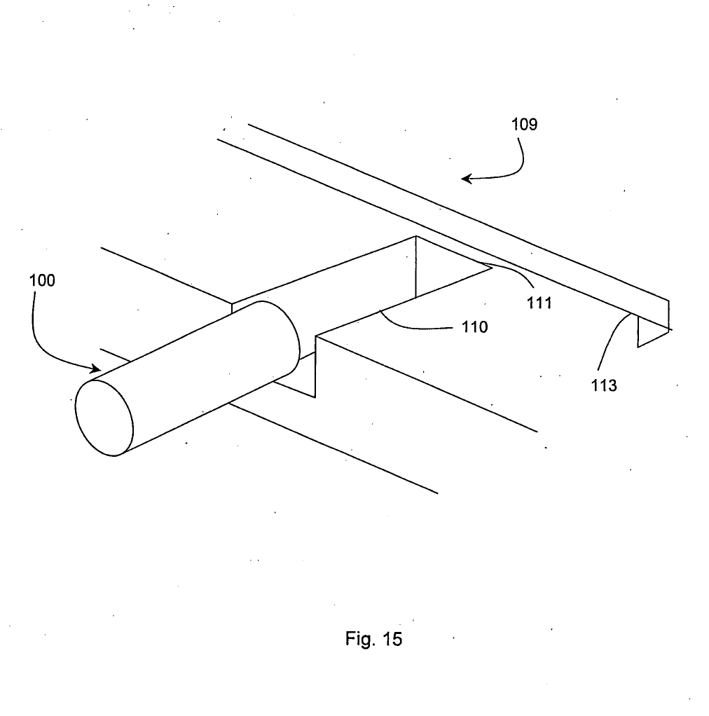

Referring to FIG. 15 a radiation interconnect 109 for an optical fibre 100 comprises a groove 110 at the end of which there is a thin transparent wall 111. The wall 111 separates the groove 110 from a fluidic microchannel 113. The depth of the groove 110 is such that the guiding core of the fibre 100 is aligned with the channel 113. In another embodiment there is no wall at the end of the groove, the end of the fibre and suitable bonding agent effectively forming part of the end wall. The arrangement of the planar fluidic interconnect enables highly efficient coupling between the input and output fluidic capillaries and the polymer microchannel. The polymer substrate is fabricated so that the interconnects are stepped height structures that enable exact matching to the inner and outer dimensions of the capillaries. The inner and outer diameters of the capillaries determine the dimensions of the polymer stepped height structures. This planar interconnection enables a low dead volume joining between the capillary and microchannel, and significantly increases the pressure tolerance of the joint due to the increased bonding area between the capillary and the substrate and superstrate. Bonding is achieved by applying UV cure epoxy after the capillary has been placed along the substrate.

Another advantageous feature of the device is the integration of two or three of injection, separation and detection components on a single polymer substrate. This is achieved using the fabrication techniques of polymer hot embossing. These fabrication techniques enable the production of the stepped height interconnect structures, microchannels, frits to contain the chemically functionalised microbeads, and alignment grooves for the optical fibres. All these features can be patterned simultaneously in the polymer substrate. The substrate is then sealed with a similar polymer material, and the capillaries and optical fibres are inserted.

Another advantageous feature of the device is the inclusion of the microchannel that intersects with the separation channel. This microchannel enables functionalised microbeads containing the stationary phase chemistry to be introduced along the separation channel. This microchannel is sealed once the microbeads are in place and the frits located at both ends of the separation channel hold the microbeads firmly in place.

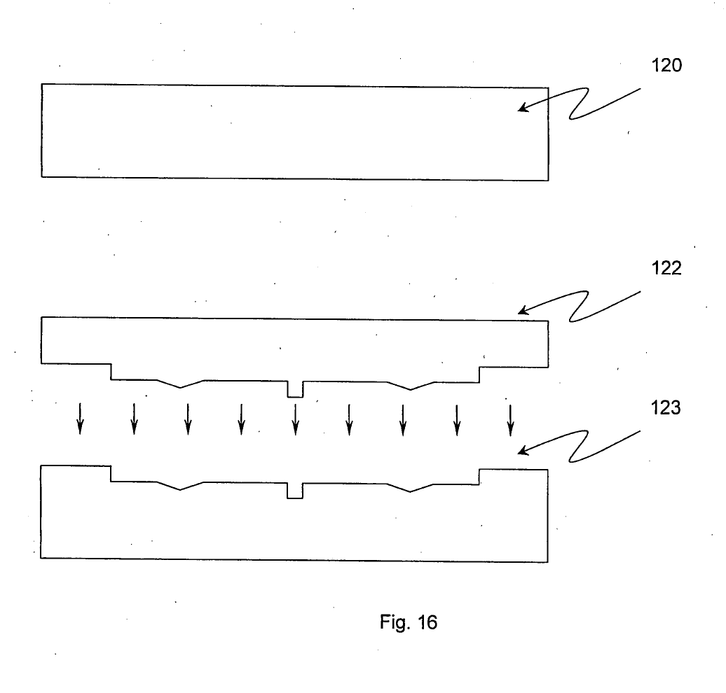

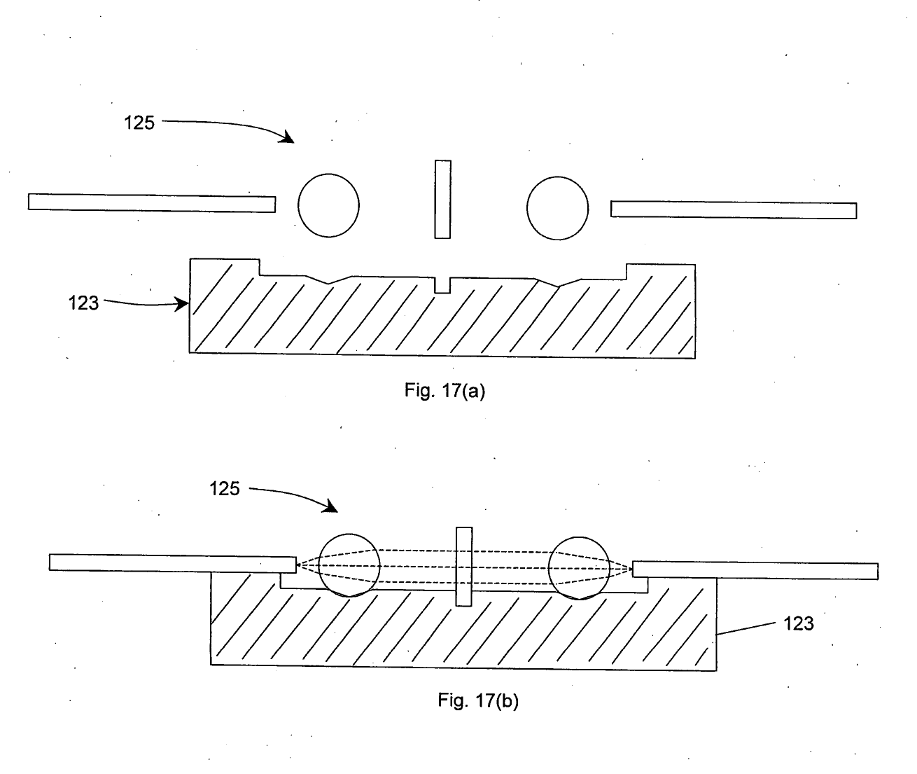

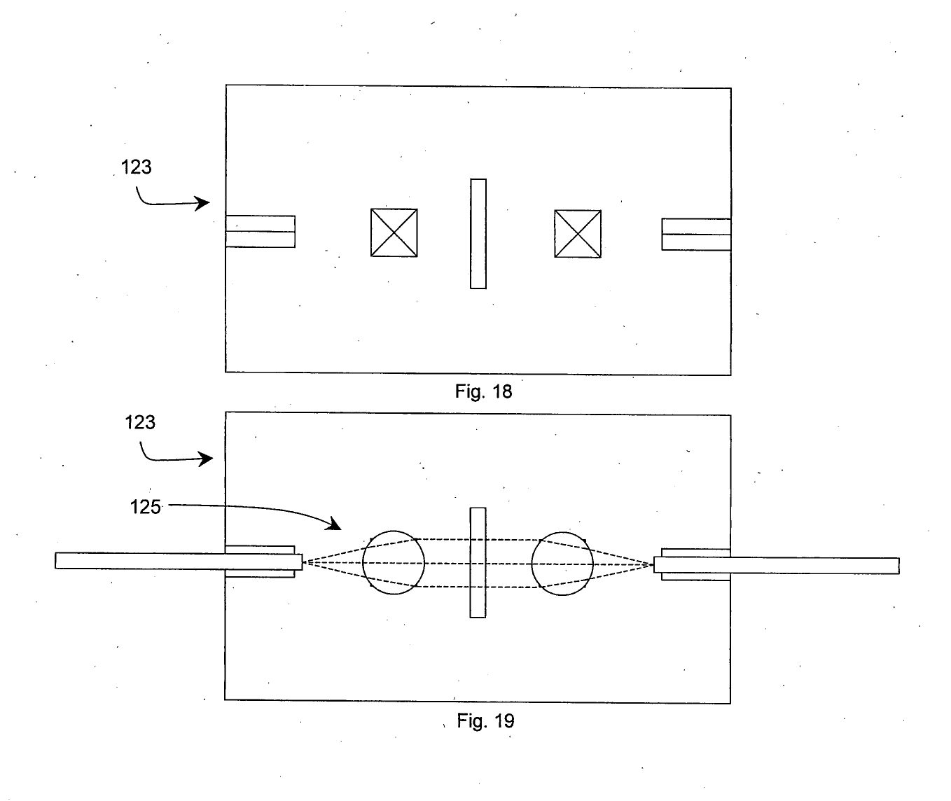

Referring to FIG. 16 a polymer blank 120 is provided, of generally rectangular block configuration. An embossing master 122 is pressed down against the top surface of the blank 122 to emboss it, providing three-dimensional optical submount microstructures. The multilevel master can enable photonic components of different sizes or heights to be aligned along a single axis. This is evident in FIGS. 17 (a) and (b), and 18 and 19 where input and output optical fibres, collimation and focusing lenses and optical filters are aligned along the optical axis. These drawings show the optical assembly 125 of two opposed optical fibres, two ball lenses, and a filter being placed on the submount 123. Emitters such as laser and LEDs, photo detectors and other photonic components such as beam splitters and diffraction gratings can also be integrated in a similar manner to the above. FIG. 20 is a photograph showing an assembly of mirrors, beam splitters (1 mm×1 mm) and a 0.3 mm ball lens on a 1 cm×1 cm submount.

The invention therefore provides for production of a polymer platform containing microstructures capable of supporting a wide range of photonic components such as emitters, detectors, refractive and diffractive optical elements, and optical fibre. An advantageous feature is the ability to define and place, with submicron accuracy, component alignment and mounting structures in the polymer material in a single process step. It enables relatively simple fabrication procedures that are suitable for the mass production of highly integrated optical components in a miniaturised packaged form.

Polymer materials can thus provide a suitable platform for supporting high levels of photonic integration. In addition, polymer manufacturing processes are inherently inexpensive, making them particularly suitable for mass production. Also, the process enables integration on a three-dimensional level, as opposed to simple planar integration. This is important as it enables photonic components of different sizes to be aligned along a single optical axis. The optical submount can also be patterned with metal microelectrodes to facilitate electrical contact of emitter and detector devices such as lasers and photodiodes to external power supplies.

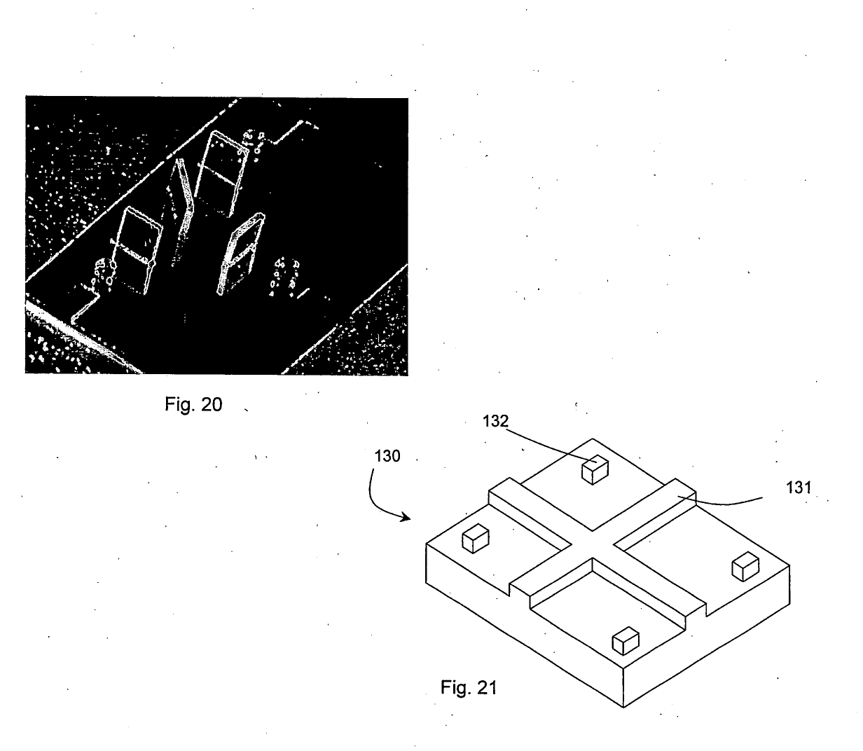

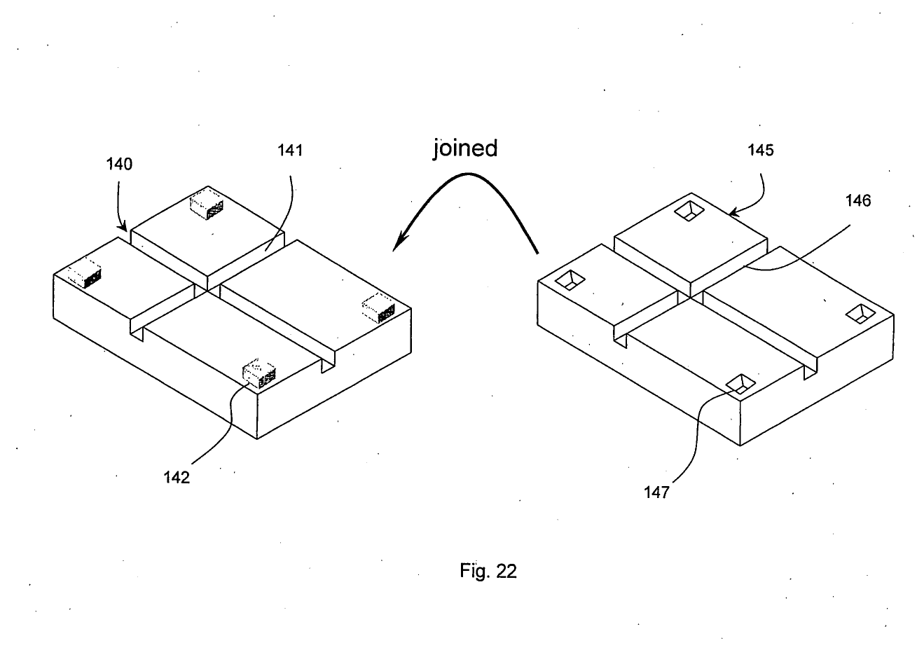

Referring to FIG. 21 an embossing master 130 has ridge waveguide structures 131 in a general cross configuration and alignment feature structures 132. The master 130 is pressed down against the top surface of a polymer blank to emboss it, providing three-dimensional microstructures. FIG. 22 shows an embossed substrate 140 formed by a different master. For embossing, the multilevel master 130 is pressed into the polymer substrate under the influence of high temperature and pressure as set out above.

As shown in FIG. 21, the multilevel master 130 can contain both waveguide and self-alignment features that are simultaneously embossed into the polymer substrate. The self-alignment features can have different dimensions to the waveguide features, this depending on the application. It is important to note that waveguides of different dimensions can be realised using a multilevel embossing master. In this particular case, the embossing master can have features of different dimensions such as height, corresponding to different frequencies of operation. This option is desirable when fabricating a waveguide structure that mixes two or more frequencies.

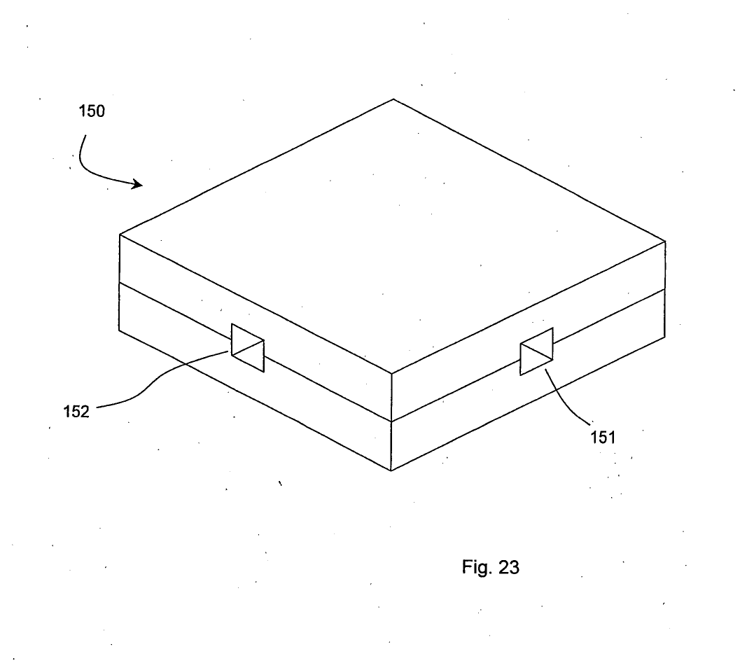

After embossing has been completed, the embossed polymer substrates and superstrate channels 141 and 146 are coated with a thin metal layer to mimic the effect of a conventional machined waveguide. The final thickness and choice of metal is determined by the frequency of operation. After the metal layer has been deposited, the substrate and superstrate are joined together to form a waveguide device 150 having internal waveguides 151, as shown in FIG. 23

It will be appreciated that polymer materials are more amenable to complex microstructures such as those often required in millimetre waveguide systems.

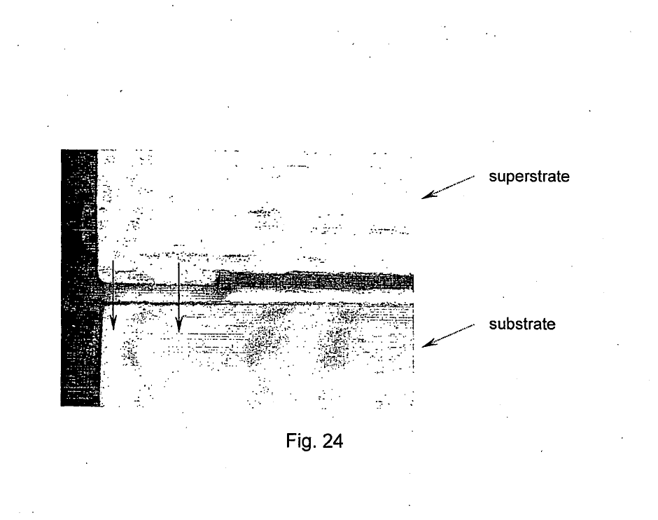

FIG. 24 is a photograph showing the interface between a different substrate and superstrate. In this case the feature to the left is an alignment feature at a corner rather than internal as shown in FIG. 22.

It will be appreciated that the invention provides for very simple and effective manufacture of microstructure devices. It is particularly advantageous where different features are to be aligned, such as a socket with a channel.

The invention is not limited to the embodiments described but may be varied in construction and detail.

1-34. (canceled)

35. A method of manufacturing a microstructure device comprising the steps of:
producing an embossing master with multi-level microstructure features, and
embossing a polymer blank with the master to provide corresponding microstructures in the blank.

36. The method as claimed in claim 35, wherein the embossing master is produced by (a) depositing a film of curable material on a base, (b) selectively exposing the material to cure it to the shape of the master and (c) developing away non-exposed material.

37. The method as claimed in claim 35, wherein the embossing master is produced by (a) depositing a film of curable material on a base, (b) selectively exposing the material to cure it to the shape of the master and (c) developing away non-exposed material; and wherein the steps (a), (b) and (c) are repeated for each of one or more subsequent layers.

38. The method as claimed in claim 37, wherein there is a different exposure pattern for at least two layers.

39. The method as claimed in claim 35, wherein the master has features for embossing both socket and channel grooves in the blank.

40. The method as claimed in claim 35, wherein the embossing master is produced by (a) depositing a film of curable material on a base, (b) selectively exposing the material to cure it to the shape of the master and (c) developing away non-exposed material; and wherein a film of material is common to features for both socket and channel grooves, and at least one subsequent film is only for the socket groove feature.

41. The method as claimed in claim 35, wherein the embossing master is produced by (a) depositing a film of curable material on a base, (b) selectively exposing the material to cure it to the shape of the master and (c) developing away non-exposed material; and wherein the material is a cross-linkable photoresist.

42. The method as claimed in claim 41, wherein the material is SU8.

43. The method as claimed in claim 35, wherein the embossing master is produced by (a) depositing a film of curable material on a base, (b) selectively exposing the material to cure it to the shape of the master and (c) developing away non-exposed material; and wherein the material is cured by exposure to UV radiation.

44. The method as claimed in claim 35, wherein the embossing master is produced by (a) depositing a film of curable material on a base, (b) selectively exposing the material to cure it to the shape of the master and (c) developing away non-exposed material; and wherein the method comprises the further step of applying a top blanket of material and developing away all of the blanket so that master features have rounded corners.

45. The method as claimed in claim 35, wherein the polymer blank is embossed to provide a microfluidic device.

46. The method as claimed in claim 35, wherein the polymer blank is embossed to provide a microfluidic device; and wherein both a substrate and a superstrate are embossed to form grooves and mating of the superstrate to the substrate forms a microfluidic channel.

47. The method as claimed in claim 35, wherein the polymer blank is embossed to provide a microfluidic device; and wherein a radiation waveguide socket and a capillary socket are formed by embossing corresponding socket grooves in polymer blanks to provide a substrate and a superstrate, and joining the superstrate to the substrate.

48. The method as claimed in claim 47, wherein the socket comprises a groove for receiving a radiation waveguide.

49. The method as claimed in claim 35, wherein the polymer blank is embossed to provide a microfluidic device; and wherein the microfluidic device is a separation and analysis device.

50. The method as claimed in claim 35, wherein the blank is embossed to form recesses of different configurations to receive and support optical components, to provide an optical submount.

51. The method as claimed in claim 35, wherein the blank is embossed to form recesses of different configurations to receive and support optical components, to provide an optical submount; and wherein the recesses include V-shaped grooves in cross-section for supporting waveguides, and a recess which is symmetrical about a normal axis for supporting a ball lens.

52. The method as claimed in claim 35 wherein the blank is embossed to include a waveguide groove structure, and a cover is placed over the structure to complete a hollow waveguide.

53. The method as claimed in claim 52, wherein the cover is also of embossed polymer material with a waveguide groove structure corresponding to that of the substrate so that together they complete a hollow waveguide.

54. The method as claimed in claim 50, wherein the recesses include V-shaped grooves in cross-section for supporting waveguides, and a recess which is symmetrical about a normal axis for supporting a ball lens; and wherein the waveguide structure is coated with a metal layer.

55. The method as claimed in claim 54, wherein the waveguide structure is evaporated with metal.

56. The method as claimed in claim 54, wherein the waveguide structure is evaporated with gold.

57. The method as claimed in claim 55, wherein the evaporation method is electron-beam or thermal evaporation.

58. The method as claimed in claim 55, wherein the metal thickness range is 0.1 microns to 50 microns.

59. The method as claimed in claim 55, wherein the waveguide is configured for millimetre-range operation.

60. The method as claimed in claim 35, wherein the microstructure features have a sub-micron accuracy.

61. The method as claimed in claim 35, wherein the polymer blank is of thermoplastic material.

62. The method as claimed in claim 35, wherein the polymer blank is heated above its glass transition temperature for embossing.

63. A microfluidic device comprising a substrate and a superstrate sealed together, the substrate and the superstrate being of polymer material and having grooves which are in registry to together form at least one socket to receive a fluidic capillary or optical waveguide, and a fluidic channel.

64. The microfluidic device as claimed in claim 63, wherein the channel terminates at the socket.

65. The microfluidic device as claimed in claim 63, wherein the channel terminates at the socket; and wherein the dimensions of the socket are such that a core of the capillary or the waveguide is aligned with the channel.

66. The microfluidic device as claimed in claim 63, wherein the device comprises both fluidic capillary sockets and waveguide sockets

67. The microfluidic device as claimed in claim 63, wherein the capillary or waveguide is bonded into the socket.

68. An optical submount comprising a polymer base with embossed recesses for receiving and supporting optical components.
